(19) United States
(12) Patent Application Publication
(10) Pub. No.: US 2020/0076037 A1
(43) Pub. Date: Mar. 5, 2020

(54) CONTACTLESS AIR-FILLED SUBSTRATE INTEGRATED WAVEGUIDE DEVICES AND METHODS

(71) Applicant: VALORBEC SOCIETE EN COMMANDITE, MONTREAL (CA)

(72) Inventors: AHMED KISHK, MONTREAL (CA); NIMA BAYAT-MAKOU, MONTREAL (CA)

(21) Appl. No.: 16/613,539

(22) PCT Filed: May 15, 2018
(86) PCT No.: PCT/CA2018/000094

§ 371 Date: Nov. 14, 2019

Related U.S. Application Data
(60) Provisional application No. 62/506,154, filed on May 15, 2017.

(51) Int. Cl. H01P 3/12

(52) U.S. Cl. CPC H01P 3/121

(57) ABSTRACT

Whilst offering promise to millimeter-wave applications and potentially also microwave applications the air-filled substrate integrated waveguides (AF-SIWs) established to date within the prior art require a complete and flawless smooth connection of the top and bottom layers to the intermediate substrate. This necessitates a high precision and costly structure to avoid signal leakage from any discontinuity or bad connection of the layers and “tight” mechanical contact between the components through closely located mechanical fixtures that hold and tighten together the AF-SIW. In order to overcome the costly and high precision fabrication and assembly processes and to enable SIWs to be used in applications where SIWs are closely located the inventors have established a contactless air-filled SIW (CLAF-SIW) which allows high performance SIWs to be implemented with increased tolerances, cheaper substrate technologies, and lower complexity.

### CROSS-REFERENCE TO RELATED APPLICATIONS

This patent claims the benefit of priority as a 371 national phase application of PCT/CA2018/000,094 entitled “Contactless Air-Filled Substrate Integrated Waveguide Devices and Methods” filed May 15, 2018 which itself claims the benefit of priority from U.S. Provisional patent application 62/506,154 entitled “Contactless Air-Filled Substrate Integrated Waveguide Devices and Methods” filed May 15, 2017, the entire contents of each being incorporated herein by reference.

### FIELD OF THE INVENTION

This patent application is related to microwave and millimeter-wave waveguides and more particularly to methods and devices that exploit combined artificial magnetic and perfect electrical conductors in conjunction with air-filled substrate integrated waveguides.

### BACKGROUND OF THE INVENTION

Recently, the rapid development of millimeter-wave applications including high-speed wireless data links, short-range radar applications, and high-resolution imaging has increased demands for low cost and high performance integrated circuits such as currently employed in microwave application. The invention of substrate integrated waveguide (SIW) technology was a promising start to satisfy these demands and has caught considerable attention over the last decade. A conventional SIW consists of two rows of metallic vias inside a double sided metallized dielectric slab, which only supports TE waveguide modes due to the vias side walls.

Accordingly, SIW is an integrated alternative to the conventional bulky metallic waveguides because of its light weight, low cost, and compactness. For this structure to be similar to the rectangular waveguide; some conditions must be met in the design of the conducting via side walls. However, it should be clear that the similarity is not necessarily complete as we must consider the fact that the leakage of the signal is possible through the periodic gaps between the adjacent metal vias not only dissipating some of the power to the dielectric out of the predetermined propagating region resulting in increased propagation losses but also crosstalk to other circuits within the same substrate.

In fact, as a guiding structure filled with dielectric material, the transmission loss along the line has always been to the higher end in the SIW-based circuits. In addition, the dielectric filling inside the waveguide reduces the average power handling capability (APHC) of the conventional SIW in comparison with the corresponding air-filled waveguides. Furthermore, SIW structures are usually designed and fabricated on the available standard laminates employed for microwave and lower frequencies. The electrical characteristics of these laminates have been characterized and verified up to certain frequency bands by the manufacturers. These laminates with the given characteristics are also utilized for higher millimeter-wave circuit designs; however, since their characteristics are unknown at high frequencies it causes ambiguity and uncertainty in the design procedure because these materials demonstrate different behavior at these frequencies than the lower frequencies.

Accordingly, at present, for accurate and careful design, the dielectric characteristics should be measured in-house, which adds expense and time. As a result, replacing the inside substrate with air is more beneficial for higher frequency applications as this removes the dominant frequency dependent component of the waveguide. Accordingly, multi-layer (ML) printed circuit board (PCB) (ML-PCB) based SIW structures containing an air-cut in the middle sections can be established to form an air-filled version of substrate integrated waveguides. More recently, these air-filled SIWs (AF-SIWs) formed from ML-PCBs have been demonstrated connected to transitions from dielectric-filled SIWs (DF-SIWs) and microstrip lines, and their superiority over conventional dielectric-filled SIW have been demonstrated in terms of loss, Q-factor, and power handling capabilities.

Whilst offering promise to millimeter-wave applications and potentially also microwave applications ML-PCB AF-SIWs established to date within the prior art require a complete and flawless smooth connection of the top and bottom layers to the intermediate substrate. In other words, the performance of such an air-filled integrated waveguide is closely correlated to the quality and the perfection of the connections, typically soldering, between the top and bottom metal plates and the intermediate layer, which necessitates the high precision and cost of the fabrication procedure. These ML-PCB AF-SIWs also have significant potential for signal leakage from any discontinuity or bad connection of the layers. Within the prior art, these smooth, flawless connections require “tight” mechanical contact between the components which is achieved by closely located screws that hold and tighten together the whole layers around the guiding medium. However, this mechanism of achieving the desired connection around the waveguide impedes its utilization for designs where the SIW lines are closely located and have to be sealed to protect any leakage between the lines.

Accordingly, it would be beneficial to provide millimeter-wave circuit designers and millimeter-wave systems designers with a design and assembly methodology allowing these limitations within the prior art to be overcome and provide innovative integrated waveguide designs for higher frequency applications. It would be further beneficial for this substrate integrated waveguide technology to offer a new class of waveguides which have lower losses at the millimeter wave frequencies than prior art methodologies.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to microwave and millimeter-wave waveguides through methods and devices that exploit combined artificial magnetic and perfect electrical conductors in conjunction with air-filled substrate integrated waveguides.

In accordance with an embodiment of the invention there is provided an electromagnetic waveguide comprising:
a substrate comprising:
   a central region filled with a material of predetermined low dielectric constant;
   left and right portions of the substrate either side of the central region, each of the left and right portions comprising a first artificial magnetic conductor (AMC) on a first side of the substrate, a second AMC on a second side of the substrate opposite the first (AMC), and a plurality of electrically conductive vias, each via electrically coupling a predetermined portion of the first AMC to a predetermined portion of the second AMC;
a first electrical conductor disposed on a first carrier over at least the central portion and the left and right portions of the substrate on the side of the first AMC with the first electrical conductor facing the first AMC and at least one of in contact with or within a predetermined distance of the AMC; and
a second electrical conductor disposed on a second carrier over at least the central portion and the left and right portions of the substrate on the side of the second AMC with the second electrical conductor facing the second AMC and at least one of in contact with or within a predetermined distance of the AMC.

In accordance with an embodiment of the invention there is provided a waveguide structure comprising:
a central substrate formed from a first predetermined material comprising:
   a central region filled with a material of predetermined low dielectric constant;
   left and right portions of the substrate either side of the central region, each of the left and right portions comprising a first artificial magnetic conductor (AMC) on a first side of the substrate, a second AMC on a second side of the substrate opposite the first (AMC), and a plurality of electrically conductive vias, each via electrically coupling a predetermined portion of the first AMC to a predetermined portion of the second AMC; and
a pair of outer substrates each formed from a second predetermined material and disposed of parallel to the central substrate, each outer substrate comprising a conductive plane on a side of the outer substrate towards the central substrate.

In accordance with an embodiment of the invention there is provided a waveguide structure comprising:
a central substrate formed from a first predetermined material comprising:
   left and right regions of the substrate either side of the central region, each of the left and right regions comprising a first artificial magnetic conductor (AMC) on a first side of the substrate, a second AMC on a second side of the substrate opposite the first (AMC), and a plurality of electrically conductive vias, each via electrically coupling a predetermined portion of the first AMC to a predetermined portion of the second AMC;
   a first central region wherein first predetermined portions of the left and right regions are disposed with a first predetermined spacing;
   a second central region wherein second predetermined portions of the left and right regions are disposed with a predetermined spacing which varies over a length of the second central region from the first predetermined spacing to a second predetermined spacing and a first cut-out centered laterally within the second central region varies in width over the length of the second central region from a first predetermined cut-out width to a second predetermined cut-out width; and
   a third central region wherein second predetermined portions of the left and right regions are disposed with the second predetermined spacing and a second cut-out centered laterally within the third central region has the second predetermined cut-out width.

In accordance with an embodiment of the invention there is provided a method comprising suppressing electromagnetic leakage within an air-filled substrate integrated waveguide employing a PEC-PEC configuration by replacing the PEC structures on the central dielectric portions substrate with artificial magnetic conductor structures (AMC).

In accordance with an embodiment of the invention there is provided an electromagnetic waveguide comprising:
an upper substrate;
a lower substrate disposed below the upper substrate;
a pair of intermediate substrates disposed between the upper substrate and the lower substrate with a separation of a predetermined width between facing edges, each intermediate substrate having a predetermined thickness; wherein
the electromagnetic waveguide has cross-sectional dimensions defined by the predetermined thickness of the pair of intermediate substrates and the predetermined width between facing edges of the pair of intermediate substrates;
the pair of intermediate substrates are formed from a first substrate or first substrates comprising a plurality of first three-dimensional (3D) resonant cells; and
the upper substrate comprises either a carrier with a conductive plane formed upon one side surface facing the pair of intermediate substrates or a second substrate comprising a plurality of second three-dimensional (3D) resonant cells;
the lower substrate comprises either a carrier with a conductive plane formed upon one side surface facing the pair of intermediate substrates or a third substrate comprising a plurality of third three-dimensional (3D) resonant cells.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts a geometry for a prior art air-filled substrate integrated waveguide;

FIG. 1B depicts a geometry for a contactless air-filled substrate integrated waveguide according to an embodiment of the invention;

FIG. 2 depicts an exemplary unit cell for an air-filled integrated waveguide according to an embodiment of the invention;

FIG. 3A depicts a dispersion diagram of a periodic structure made by the proposed air-filled integrated waveguide unit cells according to an embodiment of the invention with gap sizes of 0.015 mm (15 μm) on the both sides;

FIG. 3B depicts a dispersion diagram of a periodic structure made by the proposed air-filled integrated waveguide unit cells according to an embodiment of the invention with varying gap size;

FIG. 4 depicts in exploded perspective view of an air-filled substrate integrated waveguide configuration according to an embodiment of the invention with the proposed cells (Gap₁=Gap₂=0.015 mm)

FIG. 5A depicts the electric field distribution inside the substrate and in the gap regions of the air-filled integrated waveguide with a via diameter not meeting the conditions defined in Equations (1) and (2);

FIG. 5B depicts the electric field distribution inside the substrate and in the gap regions of the air-filled integrated waveguide with a via diameter meeting the conditions defined in Equations (1) and (2) according to an embodiment of the invention;

FIG. 5C depicts the transverse cut of the electric field distribution inside the air-filled integrated waveguide with via diameter meeting the conditions defined by Equation (1) according to an embodiment of the invention;

FIG. 6A depicts a prior art conventional air-filled substrate integrated waveguide in exploded perspective;

FIG. 6B depicts a contactless air-filled substrate integrated waveguide according to an embodiment of the invention in exploded perspective view with Gap₁=Gap₂=0.015 mm;

FIG. 7 depicts a transmission coefficient comparison between the prior art substrate integrated waveguide and contactless air-filled substrate integrated waveguide according to an embodiment of the invention;

FIG. 8A depicts the electric field distribution inside the substrate and in the gap regions of a contactless air-filled substrate integrated waveguide according to an embodiment of the invention with the texture surface spaced off the guiding medium;

FIG. 8B depicts the electric field distribution inside the substrate and in the gap regions of a prior art substrate integrated waveguide with the solid conductor planes spaced off the guiding medium;

FIG. 9A depicts transition segments from a conductor back coplanar waveguide to contactless air-filled substrate integrated waveguide according to an embodiment of the invention;

FIG. 9B depicts in detail the transitions from conductor back coplanar waveguide to dielectric filled substrate integrated waveguide;

FIG. 10 depicts in exploded perspective form a full configuration comprising input and output transition segments from a conductor back coplanar waveguide to contactless air-filled substrate integrated waveguide and central air-filled substrate integrated waveguide according to an embodiment of the invention;

FIG. 11A depicts manufactured piece-parts for central substrate of both the prior art air-filled SIW and contactless air-filled SIW according to an embodiment of the invention of similar design for comparison purposes during testing;

FIG. 11B depicts the stacked layers fastened with plastic screws;

FIG. 11C depicts a first Through Reflection Line (TRL) calibration piece-parts for testing contactless air-filled integrated waveguides according to embodiments of the invention;

FIG. 12A depicts a contactless air-filled integrated waveguide according to an embodiment of the invention assembled with launch connectors;

FIG. 12B depicts a contactless air-filled integrated waveguide according to an embodiment of the invention assembled into a test fixture;

FIG. 13 depicts transmission S₂₁ coefficient comparison between contactless air-filled integrated waveguide according to an embodiment of the invention and prior art simple air-filled substrate integrated waveguide;

FIG. 14 depicts a second Through Reflection Line (TRL) calibration piece-part set for testing contactless air-filled integrated waveguides according to embodiments of the invention;

FIG. 15 depicts a transmission S₂₁ coefficient comparison between contactless air-filled integrated waveguide according to an embodiment of the invention with the first and second TRL calibrations;

FIG. 16 depicts schematics of waveguide geometries according to embodiments of the invention with three-dimensional (3D) blocking cells in combination with a metallic waveguide;

FIG. 17 depicts schematic of waveguide geometries according to an embodiment of the invention providing leakage suppression between substrate layers within an antenna.

### DETAILED DESCRIPTION

The present invention is directed to microwave and millimeter-wave waveguides and more particularly to methods and devices that exploit combined artificial magnetic and perfect electrical conductors in conjunction with air-filled substrate integrated waveguides.

The ensuing description provides representative embodiment(s) only and is not intended to limit the scope, applicability or configuration of the disclosure. Rather, the ensuing description of the embodiment(s) will provide those skilled in the art with an enabling description for implementing an embodiment or embodiments of the invention. It is being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein are not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom,” “front” and “back” are intended for use with respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers or groups thereof and that the terms are not to be construed as specifying components, features, steps or integers. Likewise, the phrase “consisting essentially of,” and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional elements.

A “dielectric” as used herein and throughout refers to, but is not limited to, is an electrical insulator that can be polarized by an applied electric field. When a dielectric is placed in an electric field, electric charges do not flow through the material as they do in a conductor, but only slightly shift from their average equilibrium positions causing dielectric polarization. As such a dielectric may include, but not be limited to,

A “metal” as used herein and throughout refers to, but is not limited to, a material (an element, compound, or alloy) that is typically hard, opaque, shiny, and has good electrical and thermal conductivity. As such a metal may include, but not be limited, to aluminum, copper, silver, gold, platinum, tin, nickel, chromium, titanium, palladium, and tungsten.

A “via” as used herein and throughout refers to, but is not limited to, an opening formed within a substrate that is metallized over at the least the side walls from one side of the substrate to the other. The via may be filled with metallization.

A “conductor” as used herein and throughout refers to, but is not limited to, a track or a plane formed from an electrically conductive material, e.g. a metal.

“Millimeter-wave” as used herein and throughout refers to, but is not limited to, electromagnetic signals/radio frequency signals having wavelengths from one millimeter to ten millimeters, c.f. 30 GHz to 300 GHz. Such signals are commonly referred to as being within one or more of the Ka, Q, U, V, W, F, and D bands.

“Microwave” as used herein and throughout refers to, but is not limited to, electromagnetic signals/radio frequency signals having wavelengths from ten millimeters to one meter, c.f. 300 MHz to 30 GHz. Such signals are commonly referred to as being within one or more of the L, S, C, X, Ku, and K bands.

A “substrate” as used herein and throughout refers to, but is not limited to, a material compatible with the formation of structures upon (metallization) and within the substrate (vias) that presents appropriate dielectric constant, dissipation factor, the coefficient of thermal expansion, thermal conductivity at the desired operating frequencies. A substrate may include, but is not limited to, alumina (Al₂O₃), zirconia toughened alumina, aluminum nitride (AlN), silicon nitride (Si₃N₄), polytetrafluoroethylene (PTFE), polytetrafluoroethylene—glass, some thermosetting plastics, beryllium oxide, quartz, silicon carbide, silicon, gallium arsenide, and indium phosphide.

An “artificial magnetic conductor” (AMC), also known as a high impedance surface (HIS), as used herein and throughout refers to, but is not limited to, is a type of electromagnetic bandgap (EBG) material or artificially engineered material with a magnetic conductor for a specified frequency band. An artificial magnetic material is a metamaterial designed to exhibit perfect magnetic conductor (PMC) characteristics over a limited frequency band. AMC structures are typically realized based on periodic dielectric substrates and various metallization patterns. AMC unit cell structures may include, but not be limited to, mushroom-like EBG, uniplanar contact EBG, Peano curve, Hilbert curve, split ring resonators (SRR), metasolenoid, zigzag dipole, spiral, and square LC resonator.

A “perfect electrical conductor” as used herein and throughout this refers to, but is not limited to, an idealized material exhibiting infinite electrical conductivity or, equivalently, zero resistivity (cf. perfect dielectric). While perfect electrical conductors do not exist in nature, the concept is a useful model when electrical resistance is negligible compared to other effects. Typically, a PEC refers to a large planar electrical conductor.

A “tunable metamaterial” is a metamaterial with a variable response to an incident electromagnetic wave. Some metamaterials such as split-ring resonators may according to their substrate/manufacturing be electrically tunable.

Inventive Air-Filled Substrate Integrated Waveguide Configuration

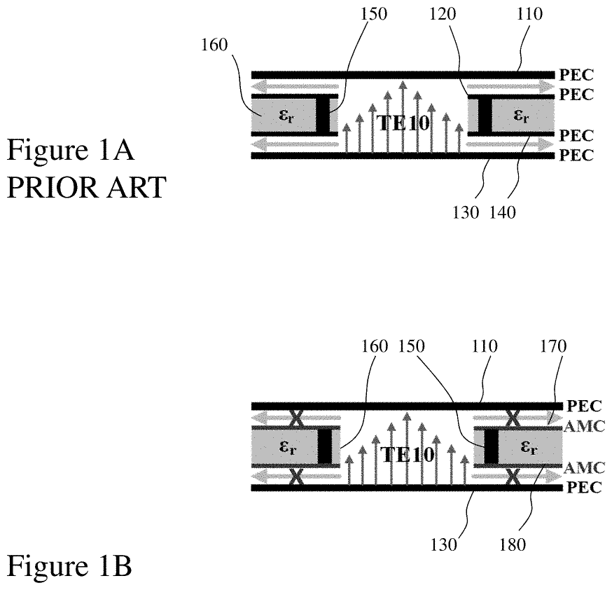

The geometry of a prior art Air-Filled Substrate Integrated Waveguide (AF-SIW) is depicted in FIG. 1A wherein the central primary layer has a top perfect electric conductor (PEC) 120 and bottom PEC 140 either side of a dielectric layer 160 through which conductive vias 150 are formed connecting them together. This primary layer is then covered by upper PEC 110 plate and lower PEC 130 plate. Accordingly, the resulting cavity formed by the four conductive walls that form the equivalent of the four walls of a conventional metal waveguide. However, as noted supra the perfect electric contacts between the primary layer (top PEC 120 and bottom PEC 140) and the surrounding plates, upper PEC 110 and lower PEC 130, to form the air-filled waveguide is a challenging task. In fact, any poor contacts of the PEC layers resulting in small/tiny gaps between adjacent PEC plates is an issue because the prior art air-filled SIW supports a strong parallel plate mode that has no cutoff frequency. Accordingly, gaps between the adjacent PEC layers (e.g. top PEC 120/upper PEC 110 or bottom PEC 140/lower PEC 130) result in coupling from the air-filled SIW to these parallel plate modes and strong leakage from the waveguide which is manifested as propagation loss. This is a significant drawback of prior art air-filled SIWs that limits their application, especially in the large scales when there are lots of risks of this propagating wave leakage.

Now referring to FIG. 1B, there is depicted in cross-section view a contactless air-filled SIW according to an embodiment of the invention. In this configuration, the top PEC 120 and bottom PEC 140 surfaces of the primary layer around the guiding medium are replaced with the artificial magnetic conductor (AMC) surfaces, being top AMC 170 and bottom AMC 180 respectively. Accordingly, these AMC surfaces form a stop band in conjunction with the PEC layers for any parallel plate mode of propagation, either transverse electric (TE) or transverse magnetic (TM). Converting the PEC-PEC connections around the air-filled waveguide to PEC-AMC suppresses any possible leakage from the guiding medium and traps the propagating waves inside the air-filled area. However, the gap height between the PEC and AMC layers is an essential parameter to determine the filtering bandwidth of the PEC-AMC parallel plate.

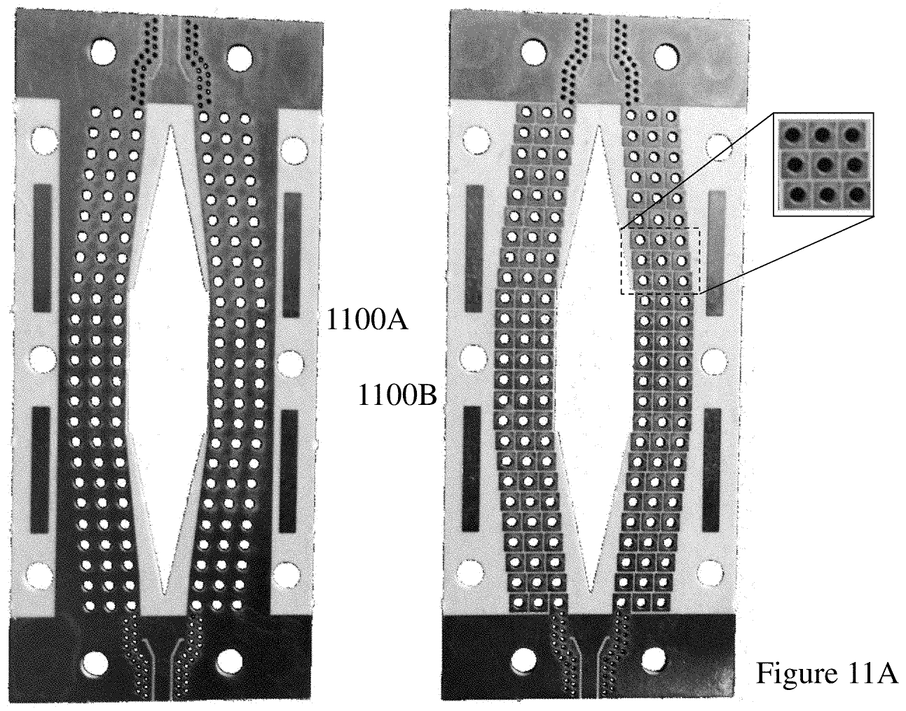

The new configuration of the air-filled substrate integrated waveguide depicted in FIG. 1B according to an embodiment of the invention is designed to operate with or without electrical contacts of the upper and lower covering plates to the central primary layer (substrate) without any possibility of leakage. Accordingly, in order to determine the height of the gap between the outer plates and the central primary substrate layer when they are loosely connected together, the inventors assembled a number of prototypes allowing the gap between the contacting layers to be determined. These prototypes, similar to the millimeter-wave circuits depicted in FIGS. 10A to 10C, once stacked together and fixed with regular—cheap plastic screws around the circuit were measured with digital Vernier calipers and compared with the nominal total thickness of different layers. As a result, the possible gap height between the PEC-AMC layers was established as typically 10 μm≤Gap≤20 μm.

Within the prior art, such gaps between the PEC-PEC layers are sufficient to cause strong leakages at the millimeter wave frequencies of operation. Therefore, regular stacking of the substrate layers would not be efficient in high-frequency applications for prior art air-filled SIW designs with PEC-PEC construction methodology requiring the more expensive connection methodologies for such designs evident within the prior art. In contrast, the inventor's modification of the design to AMC-PEC suppresses this leakage allowing low-cost regular stacking methodologies to be employed in assembling the layers using the AMC-PEC layer structure. An AMC surface may, for example, be realized with a periodic lattice of unit cells such as mushroom cells.

Contactless Air-Filled Substrate Integrated Waveguide

Within the inventive Contactless Air-Filled Substrate Integrated Waveguide (CLAF-SIW) depicted in FIG. 1B the primary layer in the centre of the stacked assembly has AMC surfaces realized on both sides off from the air-filled propagating region. Accordingly, the periodic lattice of unit cells has to be created on both sides of the substrate surrounding the air-filled region.

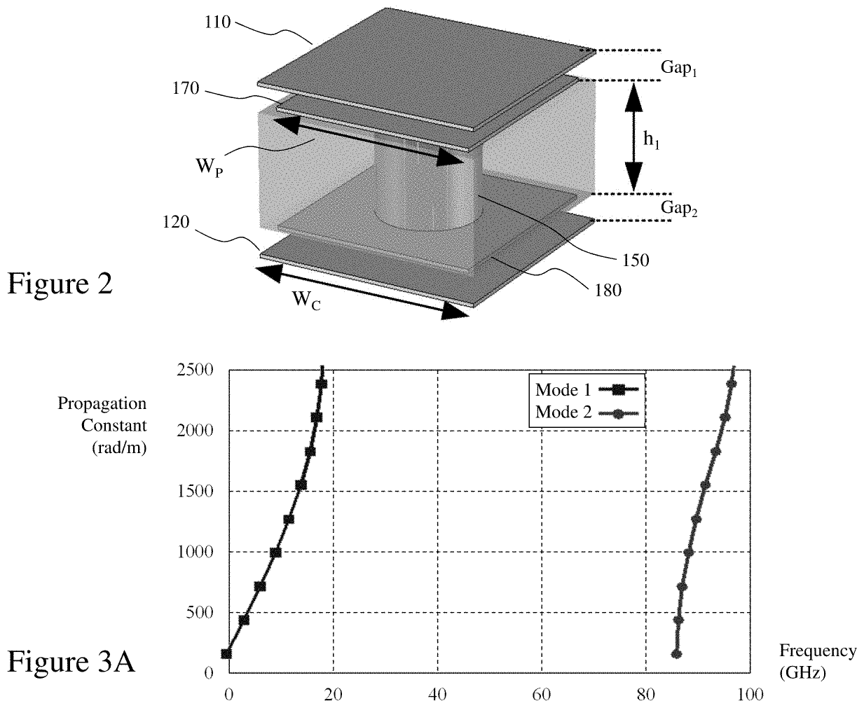

In order to realize this, the geometry of the conventional mushroom cells, which are commonly used for AMC surfaces has to be modified to make high impedance surfaces on both sides of the intermediate substrate rather than one surface as common in other AMC applications such as antennae. Therefore, unlike the traditional mushroom unit cells, which were horizontally asymmetric, the unit cell for this application has to be symmetric in order to function on the both sides to provide two identical periodic structures around the intermediate substrate. The geometry of this unit cell is given in FIG. 2. In this cell configuration, the two electrode patches, top AMC 170 and bottom AMC 180, around the substrate are connected through a metallic via 150 through the substrate and the upper/lower PEC 110/120 respectively separated by gaps, Gap₁ and Gap₂. This is similar to having the mushroom and its image on the other side of the ground plane by removing the ground plane itself.

Accordingly, for a square patch AMC the unit cell has patches W_{P}×W_{P} with a unit cell dimension of W_{C}×W_{C}, where W_{C}>W_{P}. The upper and lower gaps, Gap₁ between the upper AMC 170 and PEC 110 and Gap₂ between the lower AMC 180 and PEC 120. Within the subsequent descriptions and experiments, these gaps are 10 μm≤Gap₁&Gap₂≤20 μm Importantly, if one side of the conducting covers, e.g. upper PEC 110 or lower PEC 120, is connected to one or more patches, namely the top AMC 170 or bottom AMC 180 respectively, and hence the unit cell is similar to the simple mushroom cells within the prior art the AMC still operates adequately.

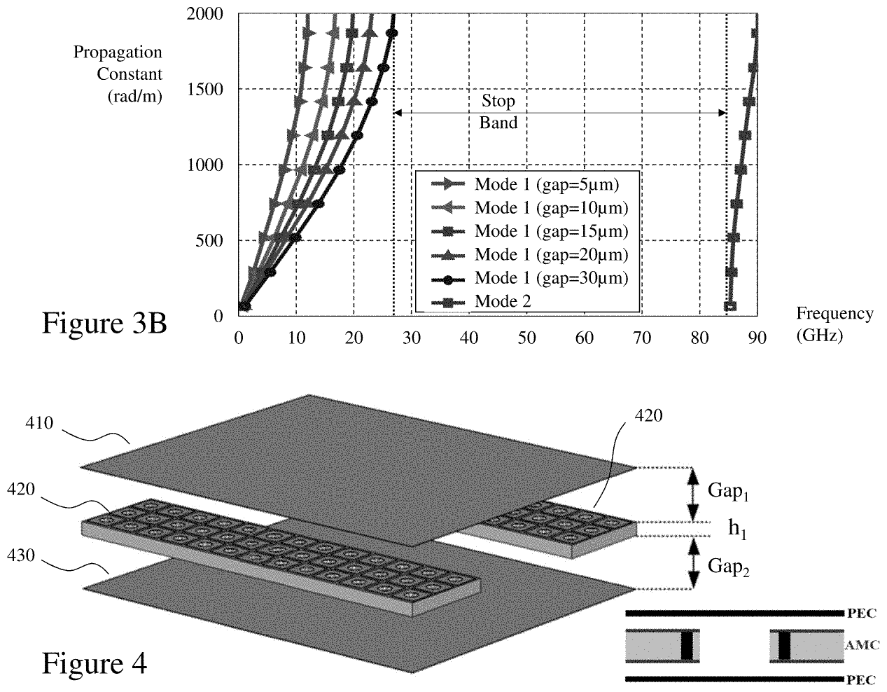

To evaluate the bandgap functioning of this unit cell modelling was undertaken for different gap heights both sides of the substrate. The resulting dispersion diagram of the periodic structure when Gap₁=Gap₂=15 μm is depicted within FIG. 3A whilst within FIG. 3B the dispersion diagrams for varying gaps at 5 μm, 10 μm, 15 μm, 20 μm, and 30 μm are presented. It is evident from FIGS. 3A and 3B that a wide bandgap exists between the first and second modes. Whilst the actual bandgap depends on the cell parameters such as patch size, via diameter, cell period, and gap height for fixed physical dimensions of the cell the gap height shifts the lower mode. As evident in FIG. 3B increasing the gap height on both sides shifts the first mode to a higher frequency thereby reducing the bandgap as the second mode is not affected. In one extreme, when the upper and lower conductors are completely connected to the patches then the lower mode (Mode 1) disappears, and the upper mode starting frequency varies with the period size.

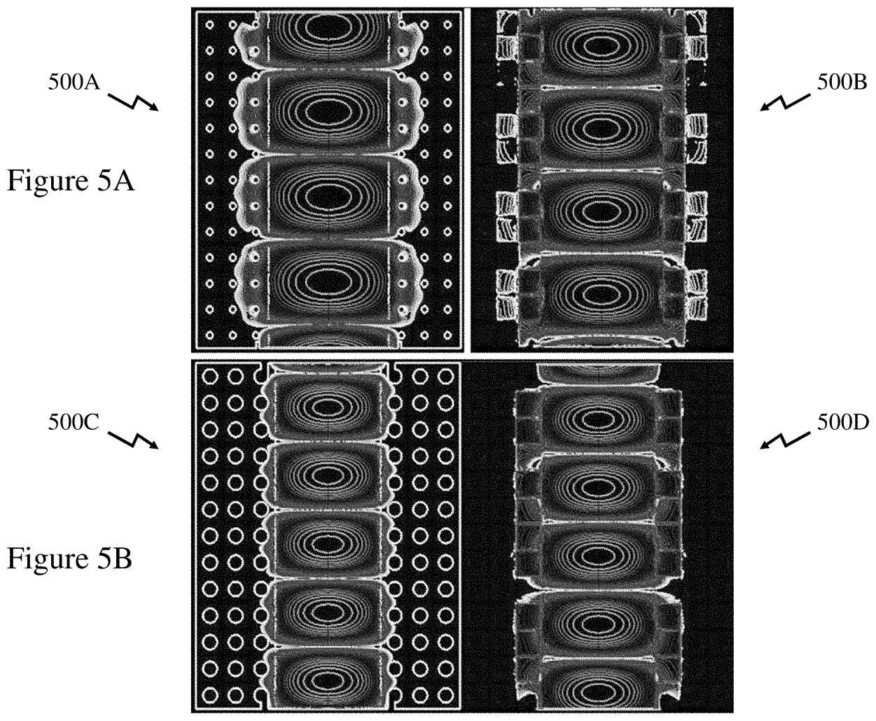

The geometry of the Contactless Air-Filled Substrate Integrated Waveguide (CLAF-SIW) is depicted in FIG. 4 comprising an upper electrical plane 410, lower electrical plane 430 and a pair of mushroom unit cell AMC substrates 420 (alternatively a single substrate with an opening within to define the air-filled region. The AMC substrate has a thickness h₁. As noted supra, the CLAF-SIW according to embodiments of the invention maintains its low loss operation even where the gaps, Gap₁; Gap₂, are not well controlled and fixed with low-cost, low complexity assembly techniques desirable for high volume low-cost consumer type applications, for example. Accordingly, these gaps could vary in different circumstances and typically will not be identical. In the “best” case when the upper conductor 410 and lower conductor 420 are completely connected to all the patches within the AMC substrates then the lower mode disappears, Mode1, and the upper mode, Mode2, starting frequency varies with the period size, and the structure operates like a completely isolated air-filled integrated waveguide.

Within conventional periodic mushroom EBG structures, the plated vias are required to simply connect the upper square patch to the lower ground plane to provide the periodic cells with inductive effect, which leads to a minimum restriction on choosing the via diameter. However, within the proposed AMC substrate with modified mushroom cell the same design freedom does not exist and any via diameter cannot be selected for the unit cells. Since this waveguide is intrinsically an SIW, the design of plated via arrays, including their spacing and diameter, around the guiding medium has to satisfy the conventional SIW conditions. The proposed configuration in which each via around the integrated guiding medium belongs to a single unit cell means the via diameter, and the periodicity of the periodic structure unit cells have to meet the conventional SIW design rules.

Accordingly, for a particular operating frequency with the guiding wavelength of λ_{g}, the periodicity of the unit cells (p_{Ucell}) and via diameter (dᵥᵢₐ) have to satisfy the relationships given by Equations (1) and (2) below.

$$\begin{matrix}{d}_{via} < \frac{{λ}_{g}}{5} & ( 1 ) \\ {p}_{Ucell} < 2 \cdot {d}_{via} & ( 2 )\end{matrix}$$

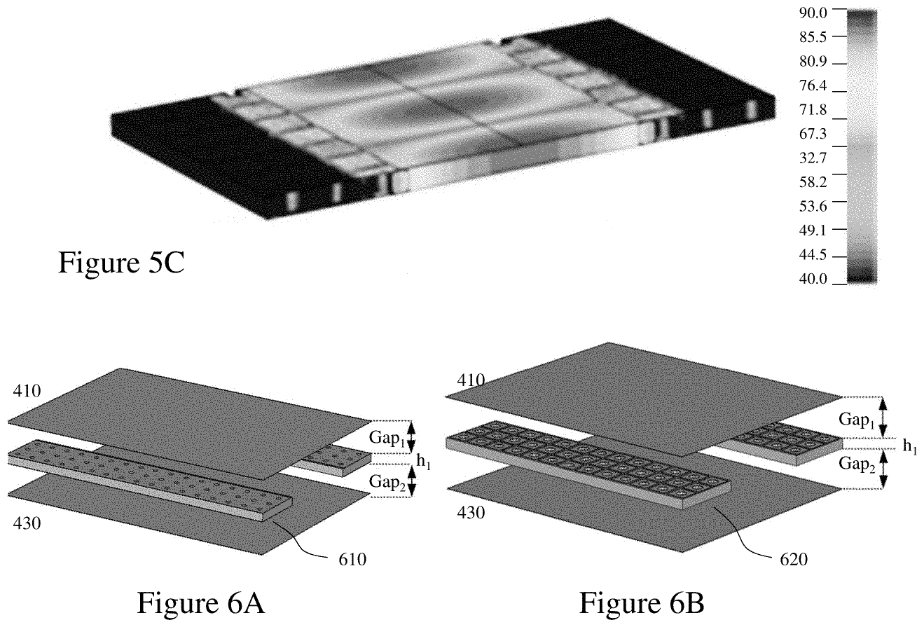

The reason that these criteria must be considered in the design of the periodic structure comes from the difference in the application of this periodic structure with those within the prior art. In the prior art periodic mushroom structure operating as an AMC surface, the periodic structure is only being excited in its surface, and it is expected to suppress the propagation on the surface. In contrast, the periodic structure utilized in the inventive CLAF-SIW is going be excited in all three regions, namely inside the substrate and the two surfaces around the substrate in which the periodic patches are disposed to suppress the propagating signals. Thus, in order to stop the leakage of the propagating waves inside the substrate the conditions in Equations (1) and (2) are required. In FIGS. 5A and 5B, a comparison is made between two air-filled integrated waveguides with and without considering these circumstances with the gap fixed at 15 microns of gap height on the other side of the intermediate substrate with covering layers.

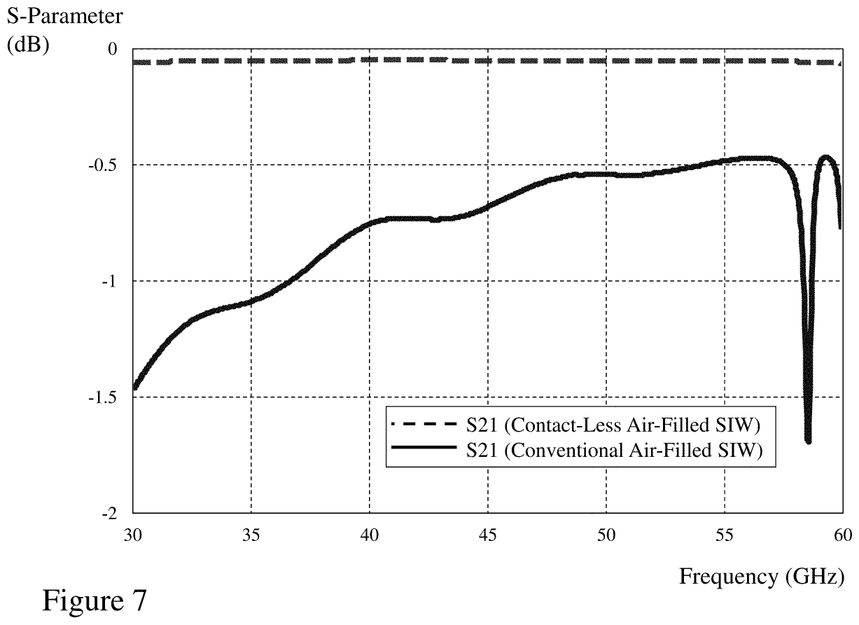

Considering, initially FIG. 5A there are depicted the electric field distributions inside the substrate (first image 500A) and in the gap region (second image 500B) of the air-filled integrated waveguide with a via diameter not meeting the conditions defined in Equations (1) and (2) (a small diameter). FIG. 5B depicts the same electric field distributions inside the substrate (third image 500C) and in the gap region (fourth image 500D) but now the via diameter meets the conditions defined by Equations (1) and (2). Accordingly, as evident from this comparison, in the waveguide with the larger via diameters there is considerably less leakage inside the substrate. Besides, as the selected frequency is in the band gap of both periodic structures, the AMC surface suppresses the propagation strongly in the gap region after the first row of the cells in the waveguide that the spacing and via diameter meet the conditions in Equations (1) and (2). FIG. 5C depicts a transverse cut of the electric field distribution inside the air-filled integrated waveguide with via diameter meeting the conditions defined by Equation (1) according to an embodiment of the invention such as depicted in FIG. 6B.

Selecting the appropriate via diameter for the periodic unit cells that satisfy the given conditions is also a factor to consider against the fabrication limitations enforced by the manufacturer(s) of the SIW which typically define a minimum pad size required at the top of each plated via hole. For instance, based on the facility accessed by the inventors, a minimum annular ring width (W_{pad}) of 10 mils (0.254 mm) is necessary for each plated via hole and a minimum possible diameter for each via should be equal to half of substrate thickness. Therefore, the minimum patch size for each unit cell would be given by Equation (3).

W_{patch(min)}=dᵥᵢₐ+2·W_{pad} (3)

As mentioned, the gap height between the layers, mostly determines the existence of the first mode and the size of the unit cells affects the second mode, which usually determines the upper limit of the band gap. Therefore, the smaller we are able to make the unit cell, the wider the band gap we can expect from the PEC-AMC parallel plate around the waveguide. However, selecting the appropriate via diameter for the periodic unit cell is also a factor to be considered against the fabrication limitations enforced by the SIW manufacturer(s). Typically, a minimum pad size (patch) is required at the end of each plated via hole. For instance, based upon the manufacturing facilities available to the inventors a minimum annular ring width W_{pad} of 10 mils (0.254 mm) is necessary for each via.

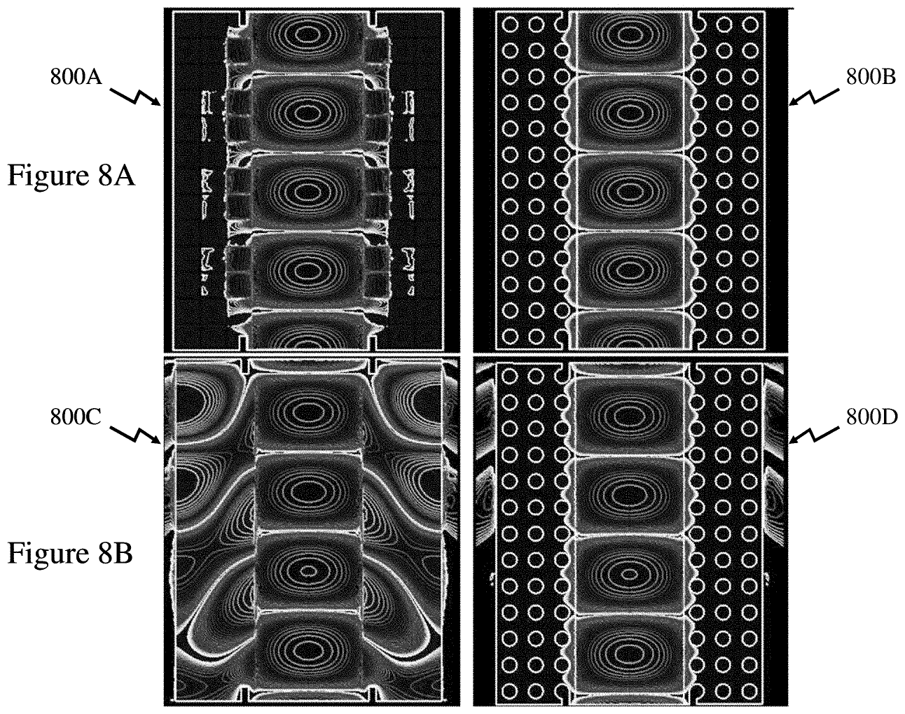

Based on the possible gap that might exist between the intermediate substrate and the covering layers, the performance of the inventive contactless air-filled waveguide was compared through simulations with the corresponding conventional air-filled substrate integrated waveguide with the same length and plated via positioning on the intermediate substrate. FIG. 6A depicts the conventional air-filled substrate integrated waveguide whilst FIG. 6B depicts the inventive contactless air-filled waveguide. In both simulation models, the waveguides are the same length and with the same via array spacing and dimensions meeting the condition of Equation (1). According, the different between the two waveguides is the texture of the conductor at the surface of the intermediate substrate surrounding the guiding medium. Air gaps of 15 micrometers (15 μm) are considered between the middle substrate and the covering metal plates. Both waveguides were excited with ideal wave ports provided by the simulator and the backside of the exciting ports attached to an absorbing boundary. The transmission coefficients response of the waveguides is depicted in FIG. 7. The simulation is performed in an ideal situation with the lateral sides of the waveguides bounded by absorbing boundary conditions. Therefore, the responses are based on allowing possible leakage of waves between the layers. As seen from above comparison, the inventive contactless air-filled integrated waveguide shows lower insertion loss than the prior art air-filled integrated waveguide by having the covering lids separated from the middle layer with a tiny gap as compared with the conventional air-filled integrated waveguide.

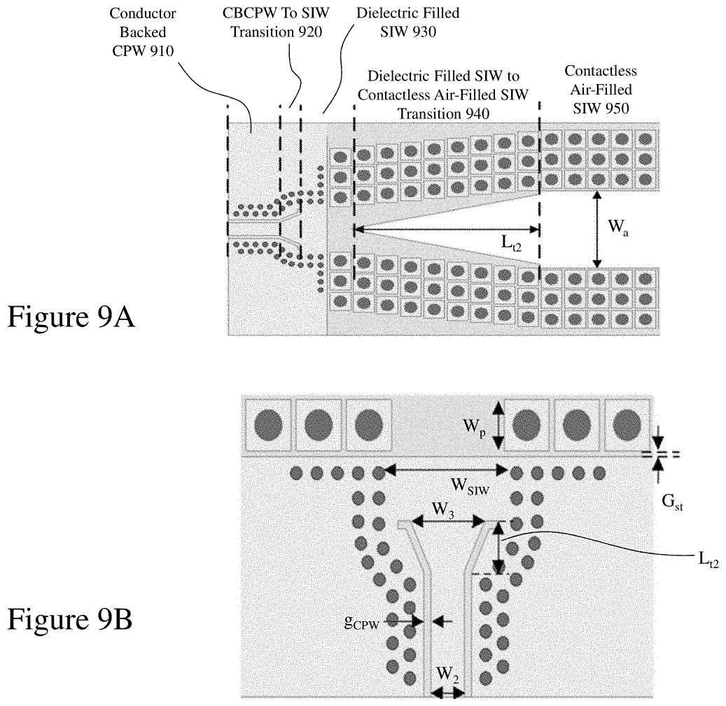

The electric field distributions inside the substrate and in the gap regions of a contactless air-filled substrate integrated waveguide according to an embodiment of the invention with the texture surface spaced off the guiding medium are depicted in FIG. 8A with first image 800A representing the gap region and second image 800B inside the substrate. The corresponding electric field distributions inside the substrate and in the gap regions of a prior art substrate integrated waveguide with the solid conductor planes spaced off the guiding medium are depicted in FIG. 8B with the third image 800C representing the gap region and fourth image 800D inside the substrate.

It is evident from these that there are lots of leaky waves within the tiny air gap of the prior art air-filled substrate integrated waveguide which causes significant losses. In contrast, the contactless air-filled substrate integrated waveguide according to an embodiment of the invention with the textured surfaces around the guiding medium suppresses the leakage of the waves in the air gaps and confines the propagating waves within the waveguide. Accordingly, the insertion loss of the contactless air-filled substrate integrated waveguide according to an embodiment of the invention is reduced significantly compared to the prior art.

Further, such simulations also show that the contactless air-filled substrate integrated waveguide according to an embodiment of the invention is not sensitive to the electrical contacts of the upper and lower covering lids with the guiding substrate. The thin portion of the dielectric on the sidewalls of the air-filled guiding medium contributes to the small insertion loss of the contactless air-filled substrate integrated waveguide according to an embodiment of the invention. Having this part of the dielectric on the air-filled substrate integrated waveguide is necessary to create the plated vias. However, this may be addressed by using the empty substrate integrated waveguide technique within the prior art where the lateral walls of the air-filled waveguide are metallized rather than using metallic vias. It would be possible to combine this technique from the empty substrate integrated waveguide with the contactless air-filled substrate integrated waveguide according to embodiments of the invention, thereby allowing the periodic structure around the guiding medium to be designed with more freedom without the requirement for considering the relationship of Equation (1). However, designing an appropriate transition from a planar feed line would be more challenging and metallizing the dielectric side edges is not always easy to implement.

Transition to Standard Feeding Line

As noted supra, the prior art and inventive waveguides depicted in FIGS. 6A and 6B respectively were excited by wave ports provided by the simulator software. However, in order to feed the proposed air-filled waveguide with standard transmission lines for feasible connections to commercial connectors, a transition is required allowing an effective interconnection between the proposed air-filled waveguide and the other standard transmission lines. Within the analysis and experiments described below the transition was designed to connect the proposed air-filled waveguide to a conventional grounded coplanar waveguide having a 50 Ohm characteristic impedance, which can easily connect to the end-launch connectors that are widely accepted by measurement instruments etc. As a standard co-planar waveguide (CPW) can be only implemented on the dielectric slab, then a transition is needed to connect it to the inventive dielectric filled SIW.

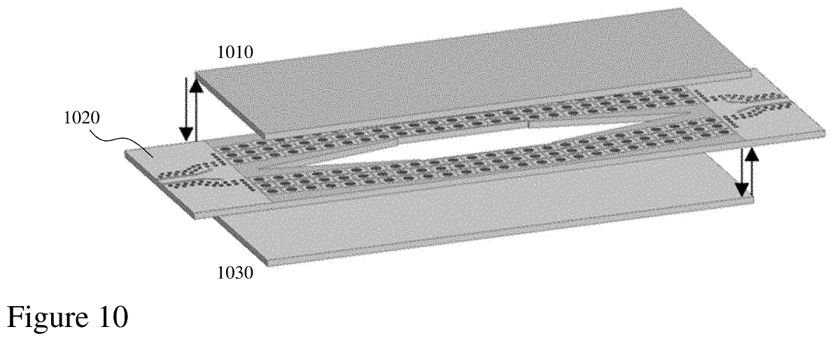

Within the prior art, the conductor-backed CPW (CBCPW) to conventional air-filled SIW (CLAF-SIW) transition that has been widely used for most of the substrate integrated circuits usually ends with tapering the CPW cuts to reach the corners of the SIW. However, the design has to be modified for different frequency bands. Accordingly, a double step transition is employed to feed a CLAF-SIW according to embodiments of the invention with a standard and widely used planar transmission line. First, a transition from the CLAF-SIW to a conventional dielectric filled SIW is made, and then a transition from the dielectric filled SIW to the grounded CPW is employed. The geometry of the designed transitions is depicted in FIGS. 9A and 9B, respectively, for the overall transition and CBCPW to SIW transition. Considering FIG. 9A, then the overall geometry depicted comprises:

First section 910—Standard conductor backed CPW (CBCPW);

Second section 920—CPCPW to SIW transition;

Third section 930—Dielectric filled SIW;

Fourth section 940—Dielectric filled SIW to air-filled SIW transition;

Fifth section 950—Contactless air-filled SIW (CLAF-SIW).

The first to third sections are depicted in more detail together with the first row of contactless mushroom EBGs of the fourth section 940 in FIG. 9B. As depicted, the initial CBCPW starts with a width W₂ and gap g_{CPW} and then transitions to width W₃ in the CBCPW to SIW transition 920 whilst the vias widen to a final separation of W_{SIW} within the dielectric filled SIW region 930. The first array of unit cells within the dielectric filled SIW for the transition to the CLAF-SIW 940 are separated by a gap Gₛₜ and have dimension W_{P}. The fourth section 940 has a length Lₜ₂ as the air-filled region expands from zero to CLAF-SIW 950 width Wₐ. Table 1 below presents design parameters for an implementation of the designed transition employed by the inventors within experiments.

TABLE 1
Transition Segment Design Parameters
for an Example CBCPW to CLAF-SIW Waveguide Transition

| Parameter | Value |
|---|---|
| W₂ | 0.98 mm |
| W₃ | 2.17 mm |
| G_{CPW} | 0.20 mm |
| G_{ST} | 0.15 mm |
| W_{SIW} | 3.66 mm |
| Lₜ₂ | 1.35 mm |
| Lₜ₁ | 11.7 mm |
| Wₐ | 5.6 mm |

All of the first to fifth sections 910 to 950 respectively may be implemented on the intermediate substrate. The periodic structure around the air-filled waveguide continues until the end of the first transition from air-filled to dielectric filled waveguide and extended as one cell inside the dielectric-filled waveguide. Accordingly, the upper and lower conductor planes which cover the whole air-filled area and the periodic structure are extended until almost the middle of the dielectric filled waveguide. At the end of the contactless environment, the entire ground planes on either side of the substrate starts and continues to the end of the substrate. The vias diameter for the rest of the transition are selected to be small by considering SIW conditions. The CBCPW-SIW transition 920 was designed for a middle frequency of 40 GHz. The backing plated vias of the transition have to be carefully positioned in order to narrow the width of the SIW in a manner similar to the tapered etched transition on the conductor to conveniently convert the TE10 mode of SIW to quasi-TEM mode of CBCPW line. These vias were continued around the CBCPW line to suppress any possible parallel plate modes between upper and lower conductors of the intermediate substrate. The width of the line, W₂, was chosen to provide a 50 Ohm characteristic impedance to be matched with the standard connectors. The overall view of the contactless air-filled waveguide with transitions covered by a couple of grounded layers is given in FIG. 10 as an exploded perspective view.

The length of the transition from CLAF-SIW to the dielectric filled SIW can also be increased to provide better insertion loss for the transitions. However, in the prototype designs, an upper limit on the overall length of the structure was set by the available test fixture. The effect of the transitions on the measured insertion loss can be removed by utilizing a through-reflection-load (TRL) calibration kit. It should be noted that the covering layers of the CLAF-SIW and the partially air-filled transition in FIG. 9 can be selected from a wide range of substrates including low-cost substrates as they simply have to provide mechanical support for the upper and lower conductors around the waveguide and interact with the mechanical fixturing holding the CLAF-SIW structure together. The contact point of the covering lids and the solid conductors of the intermediate substrate were kept as small as possible in order to have a minimum contact with the solid conductors of the intermediate substrate. At this contact point between the covering lids and the solid conductor of the intermediate substrate in the middle of the dielectric-filled SIW, two solid PEC layers are meeting each other where the existence of the gap would cause leakage towards the transitions. Accordingly, the length of this overlapping section is kept as short as possible. In other designs, the upper and lower conductors may interface with raised grounding pads forming part of the middle substrate although such design methodologies tend to increase overall costs. It would be evident that the covering layers of the air-filled medium and the partially air-filled transition are essentially only holding the covering conductors around the waveguide and, accordingly, can be from one of a wide range of low cost substrate types.

It would be evident to one of skill in the art that the actual design of the CLAF-SIW and the transition regions may vary according to the electrical properties of the substrate forming the intermediate layer as well as factors such as center operating frequency, bandwidth, etc. Accordingly, whilst three contactless mushroom EBGs are depicted for each of the left and right patterns within FIGS. 9A, 9B and 10 the number of these contactless EBGs may vary as well either generally or within specific portions of an overall design considering CLAF-SIW and transitions to other waveguide structures etc. Similarly, the design of EBGs forming the AMC structures may vary within specific portions of a design relative to others provided the design guidelines identified supra are adhered to.

Experimental Evaluation

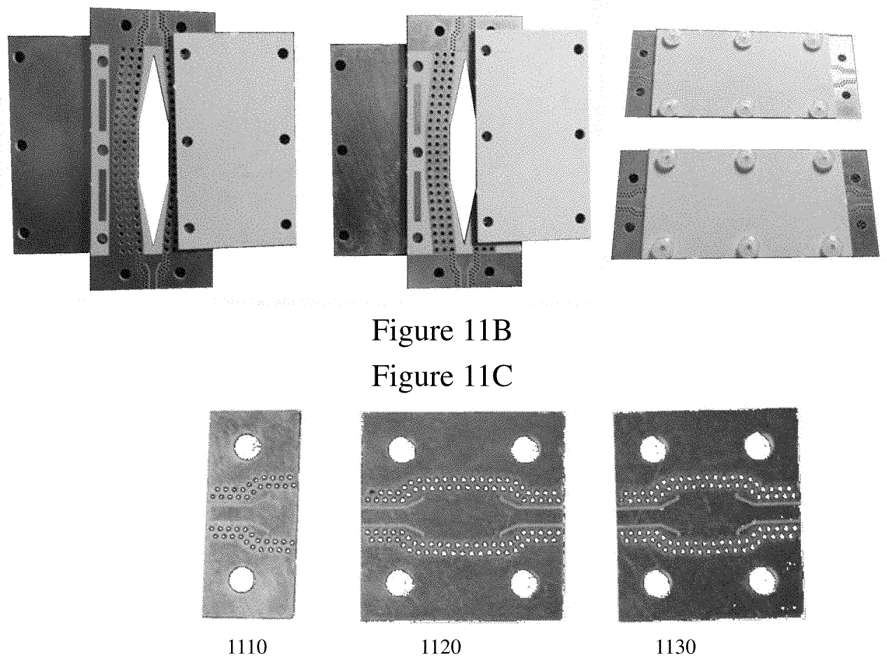

As discussed supra, the contactless air-filled substrate integrated waveguide (CLAF-SIW) was established by the inventors to solve the contact problem associated with conventional air-filled integrated waveguides. Therefore, in order to demonstrate practically its superiority, its performance has to be compared to the simple air-filled SIW. In light of this, a similar structure based on conventional waveguide has to be implemented for a fair comparison, examples of which are shown in FIG. 10A. The major difference between the proposed CLAF-SIW structure according to embodiments of the invention and the simple etched SIW is the periodic structure utilized around the substrate cut region. In other words, the solid conductor layers around the substrate cut regions in the conventional structure are replaced with periodic patches, which are connected through the substrate with plated vias. Referring to FIG. 11A first substrate 1100A is the prior art air-filled SIW test piece and the second substrate 1100B the CLAF-SIW according to an embodiment of the invention. The propagating waves inside these air-filled integrated waveguides are dealing with three regions, including the intermediate region inside the substrate and the upper and lower contact regions with the possible gaps. These gaps would happen because of the regular and cheap connection of the covering lids.

In the middle region, both waveguides are supposed to operate in the same manner as the plated vias are located in the same positions forming a waveguide with the same characteristics in the propagating waveguide medium. Therefore, the difference in the performance comparison will only come from the differences in the upper and lower layers of the main substrate as well as the surrounding medium of both configurations. Both structures were fabricated with the same length of the feeding transmission line and the same CBCPW to SIW transitions etc. Both conventional air-filled SIW and the CLAF-SIW are excited with a 50Ω CBCPW transmission line through the transition. From the feed-point of the CBCPW in the middle of the dielectric filled SIW, where the continuous conductor of the substrate stops, both the conventional air-filled SIW and the CLAF-SIW prototypes are identical. After that, the difference in the two waveguides is on the surface of the intermediate substrate around the guiding region, which is textured with the periodic square patches for the CLAF-SIW and is a continuous conductor for the conventional air-filled SIW.

The propagating waves along the air-filled SIWs are dealing with three regions, including the intermediate region inside the substrate and the upper and lower contact areas with the possible gaps. In the middle region, both waveguides are supposed to operate the same, as the plated vias are in the same positions forming a waveguide with the same characteristics. Therefore, the difference in performance only comes from the PEC-PEC and PEC-AMC connections of the covering layers with the intermediate substrate.

The top and bottom layers were selected from a range of available and relatively thick substrates to hold the solid and form PEC layers for the waveguide. The middle-etched layer of both waveguides was covered with this pair of grounded substrates and assembled using 6 plastic screws/nuts to clamp the grounded substrates to the intermediate layer. The contact condition of the covering layers with the middle one for both waveguides such as the number of screws and pressure of the layers is considered to be the same in order to have a fair comparison. In FIG. 11B the layers of both waveguides are stacked together with identical plastic screws. After assembling layers, both the prior art air-filled SIW and CLAF-SIW according to embodiments of the invention waveguides are looking exactly identical in all dimensions. In order to exclude the losses coming from the CBCPW transmission line and CBCPW to SIW transition, a TRL calibration kit as shown in FIG. 11C was prepared to remove the reference plane from the exciting port to the starting point of the contact region with covering lids where the dielectric to air-filled transition begins. As depicted in FIG. 11C, there are reflections (open circuit) 1110, line 1120, and through 1130.

It would be evident to one skilled in the art that whilst mechanical fixturing is described with respect to retaining the grounded substrates to the intermediate layer in order to form the CLAF-SIW that other techniques may be employed to mechanically retain the three elements into the predetermined physical configuration. For example, the grounded substrates may be bonded to the intermediate layer via continuous solder ring, solder bumps, conductive polymer, etc. In other embodiments of the invention the mechanical configuration may be fixed during an earlier fabrication stage such as with co-fired ceramic sheets or within semiconductor structures through sacrificial material(s) which are deposited in the etched “to-be-air-filled” region and then after subsequent metallization, upper dielectric etc. are removed through a preferential etching/dissolution stage (or thermal decomposition).

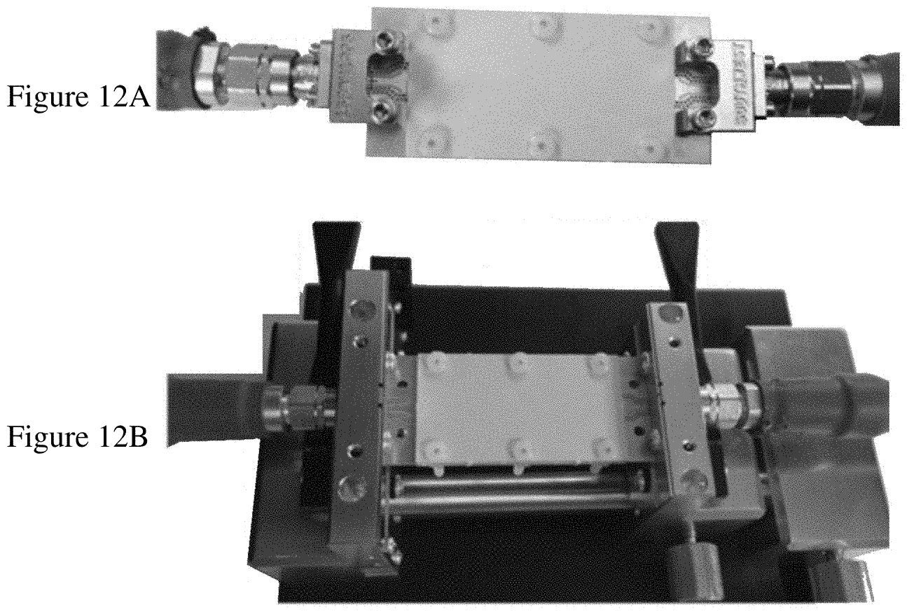

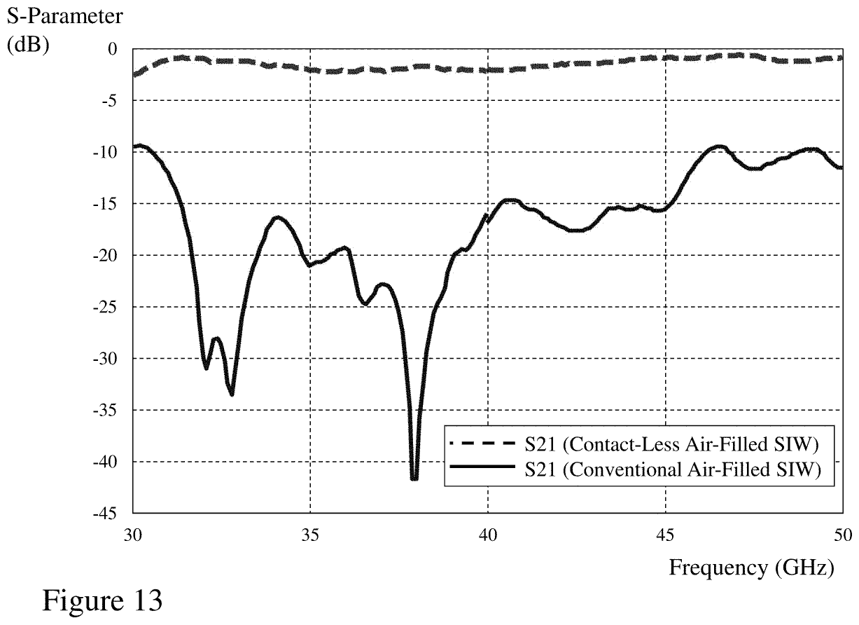

Referring to FIG. 12A an assembled test structure connected through a pair of 2.4 mm end launch connectors to the network analyzer cables and in FIG. 12B an assembled test structure is assembled within an end-launch test fixture with 2.4 mm connectors. Standard 2.4 mm connectors are rated DC-50 GHz. The measured insertion loss comparison of the CLAF-SIW according to an embodiment of the invention and the prior art air-filled SIW are depicted in FIG. 13. It is evident that there is a significant difference between the insertion losses of the two same-length air-filled integrated waveguides. The contactless air-filled integrated waveguide according to an embodiment of the invention with a periodic structure implementation of an AMC shows not only an overall lower insertion loss but is also relatively free of structure despite the use of low cost covering lids and simple mechanical assembly.

This is because the periodic structure around the guiding medium is suppressing the leakage from the possible tiny gaps of the covering layers within the prior art air-filled SIW with PEC upon the intermediate substrate. These leaky waves can easily propagate outside the guiding medium in the simple air-filled waveguide as a result of any discontinuous connection of the covering conductor planes. In fact, at this frequency band realizing the genuine connection between the contacting layers is very expensive and demands high accuracy in the fabrication process. Therefore, utilizing the proposed configuration for the CLAF-SIW is more advantageous and cost-effective.

The inventors also noted that the CLAF-SIW was significantly less susceptible to external interference from metallic objects around the CLAF-SIW relative to the conventional air-filled SIW. The conventional air-filled SIW has leaky waves that easily propagate outside the guiding medium and the inventors were able to observe variations in the scattering parameters during measurements as a metallic object was brought near the air-filled SIW under test. Such a variation not being evident with the CLAF-SIW structure according to an embodiment of the invention.

As mentioned, supra the reference plane for these measurements of the waveguides is removed from the excitation port to the starting point of the first section of the transition, which is CBCPW to SIW transition. However, the effect of the second transition section which is the dielectric filled SIW to air-filled SIW is still included in the measurement results, which adds some losses to the overall performance of the air-filled integrated waveguide, as is the discontinuity in the layer contact region. The imperfect connection of this part is also causing some losses, which are included in the waveguide performance.

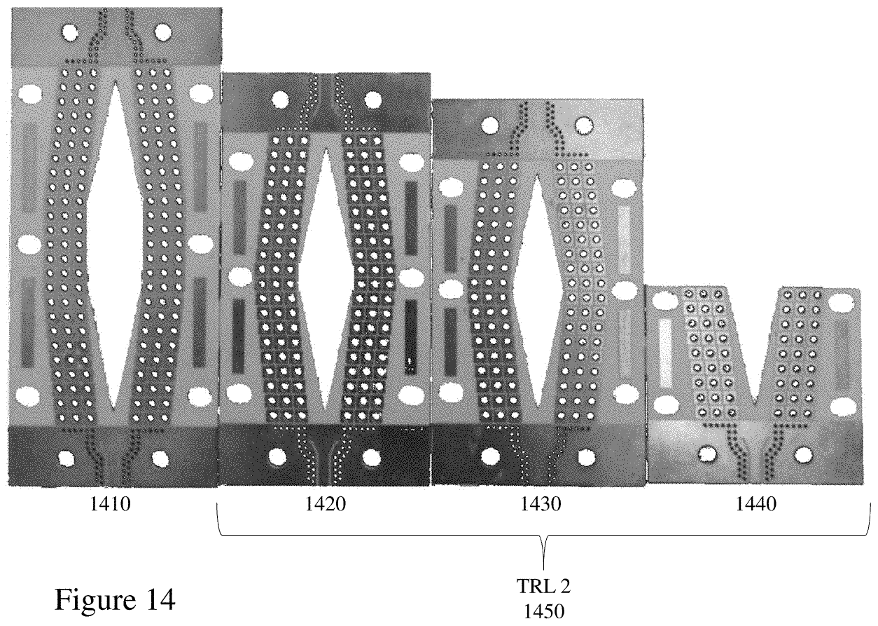

To remove these losses of the second part of the transition and the contact section of the covering layers with the intermediate substrate, the reference plane should be shifted to the end of the transition where the air-filled waveguide begins. Accordingly, another TRL calibration kit was prepared and fabricated for the CLAF-SIW as depicted in FIG. 14. As depicted this comprises an image of the CLAF-SIW structure such as depicted in second image 1100B in FIG. 11A together with the line test structure 1420, through test structure 1430, and open test structure 1440 of the second TRL calibration kit (TRL2 1450).

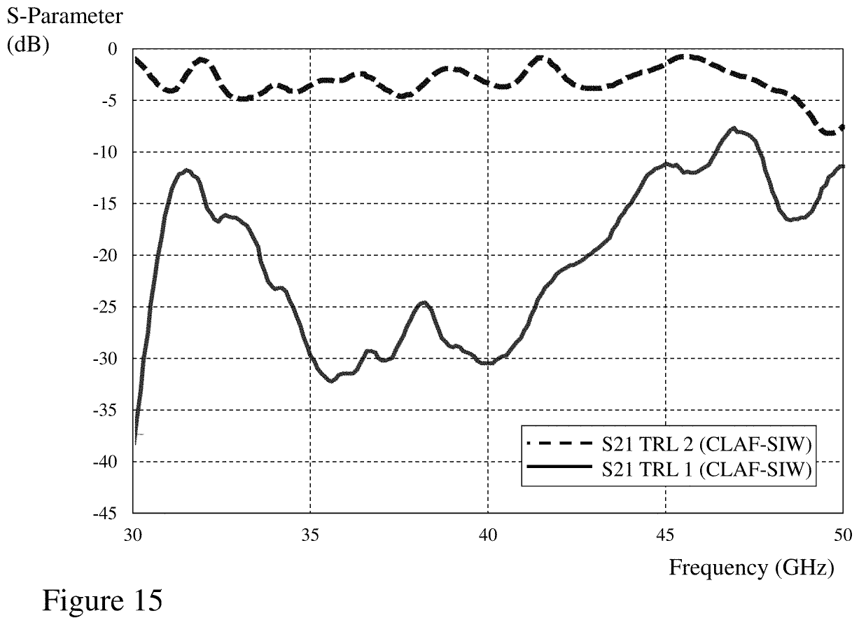

The measured transmission coefficients of the CLAF-SIW with the reference plane shifted by the second TRL calibration kit (TRL2 1450) is depicted in FIG. 15 compared to the first measurement, in which the reference planes were in the contact region of the covering lids. The measured losses within the middle section of the CLAF-SIW are less than the whole waveguide including transitions. Comparing the simulated transmission coefficients of this waveguide in FIG. 7, lots of fluctuations appeared in the measured transmission coefficients of the CLAF-SIW. This may be due to the uneven gap between the covering PEC lids and the intermediate substrate. In the simulated model, the air gaps between the intermediate substrate and covering lids were fixed on both sides. In addition, the waveguide is excited with ideal wave ports. However, in the fabricated prototypes the air-gap is not established accurately and might vary along the waveguide through the use of low cost substrates for the covering lids and the specific mechanical configuration employed to assemble the prototypes. It should also be noted that the test fixture used in the measurements has a limited upper frequency limit if 50 GHz which might also provide another reason for the high losses at the upper end of the band after applying the TRL calibration.

One of the sources of losses in the CLAF-SIW with transitions is the imperfect contact point of the covering lids with the air-filled substrate in the middle of the transition, which is not isolated, unlike the lateral sides of the CLAF-SIW. Accordingly, improvements in the design and construction of the feed section are likely to make the CLAF-SIW more robust to any discontinuities.

According to the materials selected the manufacture of the CLAF-SIW according to embodiments of the invention may exploit similar manufacturing processes and equipment as conventional prior art air-filled SIW structures. The central substrate with vias, metallization pads, dielectric, and cut-out defining the air-filled waveguide may, therefore, exploit manufacturing processes such as deposition, plating, etching, machining, drilling, and stamping.

It would be evident that embodiments of the invention have been described and depicted with the viewpoint of air-filled SIW structures and air-filled microwave waveguides generally. However, it would be evident that the central opening which is air-filled may alternatively be filled with another material of low dielectric constant such as an inert nitrogen fill, for example, if the encapsulating upper and lower conductors can be appropriate sealed or a solid material with appropriate low dielectric constant relative to the dielectric of the substrate. Such materials, commonly referred to as low-κ materials, may include, but not be limited to, doped silica (SiO₂), porous silicon dioxide, spin-on polyimide polymeric dielectrics such as polyimide, polynorbornenes, benzo-cyclobutene, PTFE and spin-on silicon-based polymeric dielectrics such as hydrogen silsesquioxane (HSQ) and methyl silsesquioxane (MSQ).

Within the preceding descriptions and depictions within FIGS. 1B to 15 respectively the embodiments of the invention provide for an isolated medium for wave propagation at very high frequencies, e.g. microwave, without requiring the complexities and costs of achieving expensive connections between the structures layers or without requiring good electrical connection between layers. Within the embodiments of the invention depicted within FIGS. 1B to 15 the structures have been depicted as being formed from an upper substrate providing a PEC layer on the upper portion of the region supporting the microwave signal propagation, a lower substrate providing a PEC layer on the lower portion of the region supporting the microwave signal propagation, and one or more substrates providing the lateral portions of the region supporting the microwave signal propagation and upper and lower AMC surfaces that face the upper and lower PEC surfaces.

However, within other embodiments of the invention the resulting air-filled waveguide may be integrated within a substrate either fully or partially or the resulting air-filled waveguide may be a completely metallic structure formed from multiple elements.

Optionally, embodiments of the invention can be employed to suppress microwave signal leakage between stacked layers without these having any specific and determined guiding medium including substrate layers or metallic layers, such as metallic flanges, instead of using expensive connections or significant numbers of mechanical joining elements, e.g. screws.

Further, within other embodiments of the invention the microwave signal blocking structure may, in addition to the combination of AMC-PEC parallel plates, be realized by exploiting a periodic structure of three dimensional (3D) resonance or resonant cells without separate definition of the layers. Accordingly, within other embodiments of the invention the layers of the, typically rectangular, microwave waveguide may be formed exploiting either non-parallel or offset holes within connecting metal pieces discretely or through patterns on connecting metal pieces such as formed by carving, sculpting, machining, etching, stamping, molding, casting, etc. Optionally, 3D resonance or resonant cells and their “substrate” may be formed through 3D printing techniques as known in the art. Accordingly, within such structures there is no clear definition of the separate AMC and PMC layers that provide the stop band region in between.

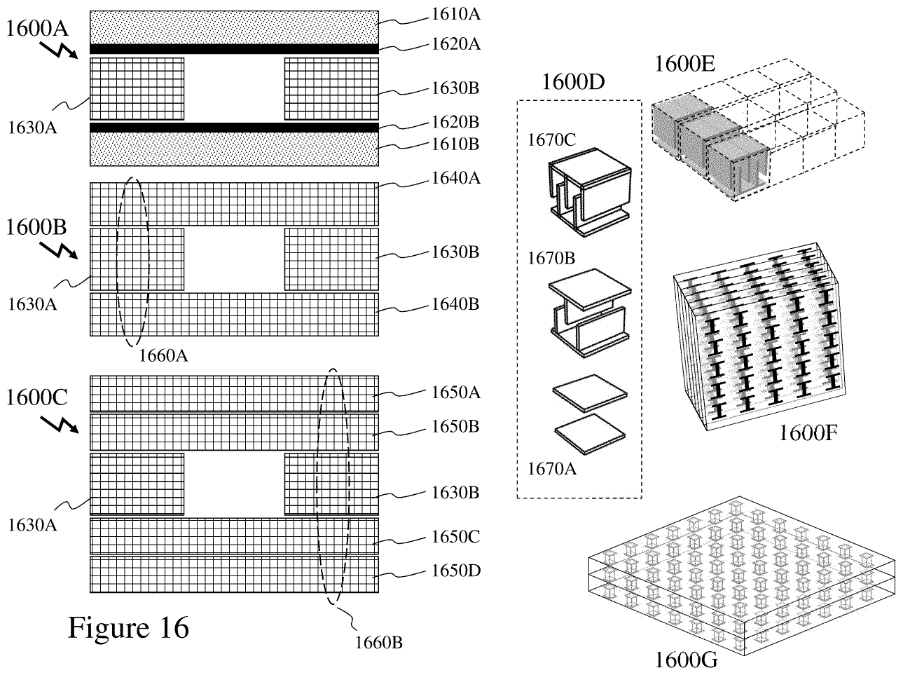

Referring to FIG. 16 there are depicted schematics of waveguide geometry examples according to embodiments of the invention exploiting three-dimensional (3D) blocking cells in combination with a metallic waveguide. Accordingly, considering first to third images 1600A to 1600C there are depicted three cross-sections perpendicular to the propagation axis of the waveguide. Within first image 1600A an upper lid 1610A has a first electrically conductive plane 1620A disposed upon one side forming a PEC lid whilst a lower lid 1610B has a second electrical conductive plane 1620B disposed upon one side. These first and second electrically conductive planes 1620A and 1620B are disposed facing one another to form the upper and lower boundaries of the microwave waveguide.

Disposed to the left and right of the region forming the microwave waveguide are first and second intermediate layers 1630A and 1630B respectively which form the left and right boundaries of the microwave waveguide and are formed from periodic structures of three-dimensional (3D) blocking cells. Accordingly, in combination with the designs described and depicted in FIGS. 1B to 15 there may be loose “connection” or gaps between

Alternatively, as depicted in second image 1600B the upper lid 1610A and lower lid 1610B are replaced with first and second covers 1640A and 1640B respectively which are similarly formed from periodic structures of 3D blocking cells as are the first and second intermediate layers 1630A and 1630B respectively which form the left and right boundaries of the microwave waveguide. Accordingly, the vertical geometry for the left and right regions external to the microwave guide are formed completely from periodic structures of 3D blocking cells.

Alternatively, as depicted in third image 1600C the upper lid 1640A is now a first pair of periodic 3D blocking cell substrates 1650A and 1650B respectively whilst the lower lid 1640B is now a second pair of periodic 3D blocking cell substrates 1650C and 1650D respectively. Optionally, 3 or more layers may be employed rather than the single layer upper and lower covers 1640A and 1640B respectively or the first and second pairs periodic 3D blocking cell substrates 1650A/1650B and 1650C/1650D respectively. Optionally, the first and second intermediate layers 1630A and 1630B respectively may be formed from two or more layers of periodic 3D blocking cell substrates.

A variety of periodic 3D blocking cells may be employed such as those depicted in fourth image 1600D with first to third blocking cells 1670A to 1670C respectively, for example. First blocking cell 1670A comprises a pair of parallel plates, a 3D interleaved parallel plates with vertical overlap between a central upper plate and a pair of lower parallel plates, and a 3D interleaved parallel plates with vertical overlaps between a pair of lower parallel plates and upper set of three plates. Accordingly, a periodic 3D blocking cell substrate as described and depicted in first to third images 1600A to 1600C respectively may exploit an two-dimensional (2D) array of periodic 3D blocking cells as depicted in fifth image 1600E or alternatively a 3D array of periodic 3D blocking cells as depicted, for example, in sixth and seventh images 1600F and 1600G respectively.

Within embodiments of the invention each of the substrates providing the upper portion of the waveguide, e.g. upper lid 1610A, the lower portion of the waveguide, e.g. lower lid 1610B, and the intermediate portion of the waveguide, e.g. first and second intermediate layers 1630A and 1630B, may employ a single design of 3D resonant cell or it may employ two or more 3D resonant cells.

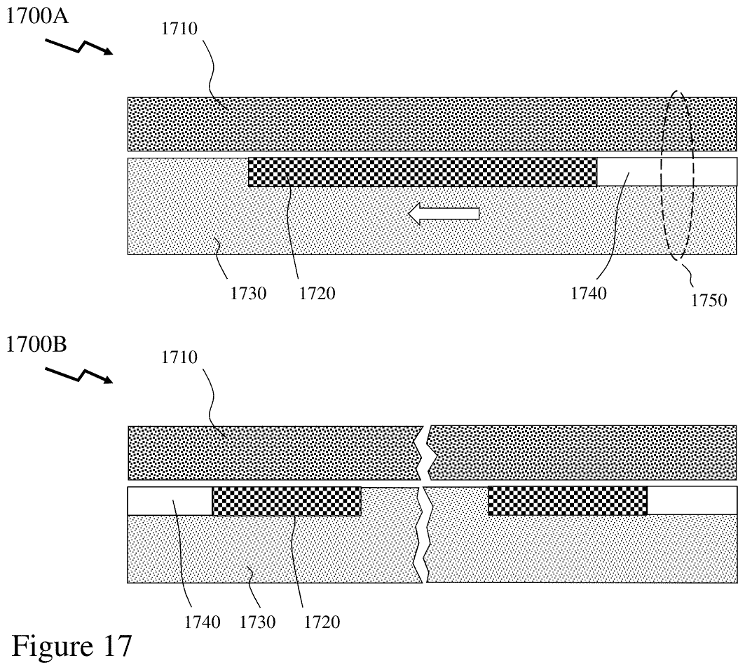

Now referring to FIG. 17 there is depicted a first schematic 1700A of a waveguide geometry according to an embodiment of the invention providing leakage suppression between substrate layers within an antenna wherein the antenna elements 1720 are coupled to a waveguide 1740 formed within a substrate 1730 with a cover layer 1710. Accordingly, substrate 1730 may combine the lower substrate and left/right intermediate substrates together with the cover layer 1720 such as described and depicted above in respect of FIGS. 1B to 16 respectively wherein leakage between the substrate 1730 and cover layer 1710 is prevented. Accordingly, as depicted in second schematic 1700B multiple antenna elements 1720 may be integrated onto the substrate 1730 wherein leakage between the multiple antenna elements 1720 is reduced as leakage between the substrate 1730 and cover layer 1710 is prevented.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of the steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An electromagnetic waveguide comprising:
a substrate comprising:
a central region filled with a material of predetermined low dielectric constant;
left and right portions of the substrate either side of the central region, each of the left and right portions comprising a first artificial magnetic conductor (AMC) on a first side of the substrate, a second AMC on a second side of the substrate opposite the first (AMC), and a plurality of electrically conductive vias, each via electrically coupling a predetermined portion of the first AMC to a predetermined portion of the second AMC;
a first electrical conductor disposed on a first carrier over at least the central portion and the left and right portions of the substrate on the side of the first AMC with the first electrical conductor facing the first AMC and at least one of in contact with or within a predetermined distance of the AMC; and
a second electrical conductor disposed on a second carrier over at least the central portion and the left and right portions of the substrate on the side of the second AMC with the second electrical conductor facing the second AMC and at least one of in contact with or within a predetermined distance of the AMC.

2. The electromagnetic waveguide according to claim 1, wherein
each of the first AMC and second AMC are a periodic array of electrical pads wherein
each electrical pad within the first AMC is electrically isolated from all other electrical pads within the first AMC;
each electrical pad within the second AMC is electrically isolated from all other electrical pads within the second AMC; and
each pad within the first AMC is electrically connected to a predetermined pad of the second AMC by a predetermined electrically conductive via of the plurality of electrically conductive vias.

3. The electromagnetic waveguide according to claim 1, wherein
each of the first AMC and second AMC is at least one of an electromagnetic bandgap (EBG) material or artificially engineered material with a magnetic conductor for a specified frequency band.

4. The electromagnetic waveguide according to claim 1, wherein
each of the first AMC and second AMC are periodic dielectric structures with a predetermined metallization pattern.

5. The electromagnetic waveguide according to claim 1, wherein
each of the first AMC and second AMC are formed from a plurality of AMC unit cell structures, the AMC unit cell structure selected from the group comprising mushroom-like EBG, uniplanar contact EBG, Peano curve, Hilbert curve, split ring resonators (SRR), metasolenoid, zigzag dipole, spiral, and square LC resonator.

6. A waveguide structure comprising:
a central substrate formed from a first predetermined material comprising:
a central region filled with a material of predetermined low dielectric constant;
left and right portions of the substrate either side of the central region, each of the left and right portions comprising a first artificial magnetic conductor (AMC) on a first side of the substrate, a second AMC on a second side of the substrate opposite to the first (AMC), and a plurality of electrically conductive vias, each via electrically coupling a predetermined portion of the first AMC to a predetermined portion of the second AMC; and
a pair of outer substrates each formed from a second predetermined material and disposed parallel to the central substrate, each outer substrate comprising a conductive plane on a side of the outer substrate towards the central substrate.

7. The waveguide structure according to claim 6, further comprising
a first spacing means disposed between the central substrate and a first outer substrate of the pair of outer substrates to establish a predetermined separation between the conductive plane of the first outer substrate and the associated one of the first AMC and the second AMC it is disposed towards; and
a second spacing means disposed between the central substrate and the other outer substrate of the pair of outer substrates to establish a predetermined separation between the conductive plane of the other outer substrate and the associated other one of the first AMC and the second AMC it is disposed towards.

8. The waveguide structure according to claim 7, wherein
the predetermined separation is between ten micrometers (10 μm) and twenty micrometers (20 μm).

9. The waveguide structure according to claim 7, wherein
a first predetermined portion of each of the first spacing means and the second spacing means are formed upon the central substrate and a second predetermined portion of the each of the first spacing means and the second spacing means are formed upon the respective outer substrate of the pair of outer substrates.

10. The waveguide structure according to claim 6, wherein
the fixturing means establishes a mechanical separation between each of the outer substrates of the pair of outer substrates and the central substrate which is between zero and a predetermined maximum value; wherein
the mechanical separation is either constant or variable along the length of the waveguide structure.

11. A waveguide structure comprising:
a central substrate formed from a first predetermined material comprising:
left and right regions of the substrate either side of the central region, each of the left and right regions comprising a first artificial magnetic conductor (AMC) on a first side of the substrate, a second AMC on a second side of the substrate opposite the first (AMC), and a plurality of electrically conductive vias, each via electrically coupling a predetermined portion of the first AMC to a predetermined portion of the second AMC;
a first central region wherein first predetermined portions of the left and right regions are disposed with a first predetermined spacing;
a second central region wherein second predetermined portions of the left and right regions are disposed with a predetermined spacing which varies over a length of the second central region from the first predetermined spacing to a second predetermined spacing and a first cut-out centered laterally within the second central region varies in width over the length of the second central region from a first predetermined cut-out width to a second predetermined cut-out width; and
a third central region wherein second predetermined portions of the left and right regions are disposed with the second predetermined spacing and a second cut-out centered laterally within the third central region has the second predetermined cut-out width.

12. The waveguide structure according to claim 11, further comprising:
a pair of outer substrates each formed from a second predetermined material and disposed parallel to the central substrate, each outer substrate comprising a conductive plane on the side of the outer substrate towards the central substrate and covering at least those portions of the central substrate defined by the left and right regions, the first central region, the second central region, and the third central region.

13. The waveguide structure according to claim 12, further comprising at least one of a:
a fixture designed to mechanically hold the central substrate and outer substrates in a predetermined relationship; and
a fixturing means establishing a mechanical separation between each of the outer substrates of the pair of outer substrates and the central substrate which is between zero and a predetermined maximum value, wherein the mechanical separation is either constant or variable along the length of the waveguide structure.

14. A method comprising:
suppressing electromagnetic leakage within an air-filled substrate integrated waveguide employing a PEC-PEC configuration by replacing the PEC structures on the central dielectric portions substrate with artificial magnetic conductor structures (AMC).

15. The method according to claim 14, wherein
the AMC structures suppress parallel plate modes between the PEC-PEC elements arising from imperfect interfaces between them.

16. An electromagnetic waveguide comprising:
an upper substrate;
a lower substrate disposed below the upper substrate;
a pair of intermediate substrates disposed between the upper substrate and the lower substrate with a separation of a predetermined width between facing edges, each intermediate substrate having a predetermined thickness; wherein
the electromagnetic waveguide has cross-sectional dimensions defined by the predetermined thickness of the pair of intermediate substrates and the predetermined width between facing edges of the pair of intermediate substrates;
the pair of intermediate substrates are formed from a first substrate or first substrates comprising a plurality of first three-dimensional (3D) resonant cells; and
the upper substrate comprises either a carrier with a conductive plane formed upon one side surface facing the pair of intermediate substrates or a second substrate comprising a plurality of second three-dimensional (3D) resonant cells;
the lower substrate comprises either a carrier with a conductive plane formed upon one side surface facing the pair of intermediate substrates or a third substrate comprising a plurality of third three-dimensional (3D) resonant cells.
